(19) United States
(12) Patent Application Publication
(10) Pub. No.: US 2025/0000736 A1
(43) Pub. Date: Jan. 2, 2025

(54) Pivotable Locking Mechanism of Multifunctional Side Table

(71) Applicant: Linet spol. s.r.o., Slany (CZ)

(72) Inventors: Bronislav Siuda, Trinec (CZ); Martin Simicek, Bernartice nad Odrou (CZ)

(73) Assignee: Linet spol. s.r.o., Slany (CZ)

(21) Appl. No.: 18/707,593

(22) PCT Filed: Nov. 8, 2022
(86) PCT No.: PCT/CZ2022/000045

§ 371 Date: May 5, 2024

(30) Foreign Application Priority Data
Nov. 8, 2021 (CZ) PV 2021-513

(51) Int. Cl. A61G 15/10

(52) U.S. Cl. CPC A61G 15/10

(57) ABSTRACT

A pivotable locking mechanism of a side table of a multifunctional medical chair, which is used for placement of care giver instruments, catering of patients, or for any other activities and needs of patients. The side table has several functions, including, for example, moving the table desk in the horizontal plane towards and outwards of a patient, rotating the table desk horizontally around a vertical axis of rotation of the table desk, and removing the side table from the chair. The table comprises a mechanism for removing the table from a multifunctional chair.

### TECHNICAL FIELD

The invention relates to a pivotable locking mechanism of a side table of a multifunctional medical chair. The side table desk of the multifunctional medical chair is used for putting down of caregiver's instruments, catering of patients, or can be used for any other activities and needs of patients. Due to the fact, that such side tables may be used for many different purposes, they have several positioning functions: shifting the table desk towards and outwards of a patient, turning the table rightward or leftward, or complete dismantling of a table from the chair.

### PRIOR ART

Medical multifunctional chairs are used before and after a medical intervention within one-day surgery area, for transport of patients, recovery after an intervention or they serve for non-invasive procedures such as colonoscopy/gastroscopy examinations, endoscopy examinations, minor surgeries etc. Medical chairs also meet requirements of medical processes in the field of dialysis, oncological treatment, or blood donation. Most of these multifunctional chairs comprise a support deck that is divided into three parts, and the chair can thus be positioned to the position of a hospital bed or an emergency stretcher. Multifunctional chairs, as already mentioned, are used for minor interventions and patient care, but most of them do not have any side table or table desk that would serve for multiple purposes. Mostly in the places where these multifunctional medical chairs are used, medical chairs are completely free of side tables or any table desk, and the need for a side table is solved in the form of mobile serving tables, or separate tables with a cabinet. In case that these medical chairs have any side tables, these side tables are not large enough, nor do they have sufficient strength and necessary variability for turning and pushing or being pushed away. Also, these medical chairs usually only have a plastic or wooden boards attached on hooks or swivel hinges to the outer side of the armrest or to the side rail, which folds from the stored vertical position to a horizontal position along the armrest, which usually allows only to put away things of a lighter weight. However, due to the structure and strength of the securing, this type of tables is not safe or practically usable at all.

Another option is a table desk inserted separately in a storage case or hung on hooks on the underside of the backrest part of the support deck. This type of separate table desk must be removed by the staff or a caregiver from the case or hinge and then clicked, hooked or inserted into the holes on the armrest of the multifunctional chair, but the patient must already be sitting on the chair and in case the table is loaded with stored items or possibly refreshments, the patient cannot leave such chair himself without help of another person, if he, himself, is not able to lift and remove the entire table desk. Such table desks are not very comfortable for users or the staff in terms of leaving the chair. Also, these table desks do not allow staff to use them as a storage area for medical equipment and instruments, when the staff needs access to a patient and to medical equipment at the same time (e.g. needles, disinfectants, scalpels, scissors or sewing material, etc.).

The solution presented herein discloses a multi-purpose positionable side table, which aims to be used both for a patient in terms of storing his personal items, using the table desk as a dining table or a side table, and also for medical staff to put away medical material during treatment of a patient. In parallel, the patient can move this table slightly or turn away from him to easily leave the multifunctional chair.

Existing multifunctional chairs, as stated above, usually do not have these side tables or have completely different, unsuitable table desks that do not meet some of the above-mentioned requirements for strength, way of attachment, load-bearing capacity, safety or multi-functionality of use with enough space for care or leaving the chair. Another aim is also to attach such table desk to an existing multifunctional chair additionally, in case the customer is not interested to have such side table when purchasing a hospital bed.

### SUMMARY OF THE INVENTION

The invention is defined by the appended claims.

The aforementioned issues and shortcomings of existing multifunctional chairs are solved by a technical solution presented in the form of a multifunctional chair comprising a multifunctional adjustable pivotable side table. This multifunctional table has several functions, preferably at least three, namely: moving the table desk in the horizontal plane towards and outwards a patient, rotating the table desk horizontally around the vertical axis of rotation of the table desk, and removing the side table from the chair, wherein the table comprises a mechanism for removing the table from a multifunctional chair at all. This positionable side table solves all the aforementioned shortcomings of existing multifunctional chairs for one-day surgery or short-term medical care.

The multifunctional or multi-purpose adjustable pivotable side table comprises a table desk, where the top part of the table desk serves as a storage surface for laying down different subjects of a patient or caregivers. The table desk may be produced from wood, plastic material, laminated material, or any other suitable material.

The table desk comprises a table desk frame on the bottom part. The table desk frame comprises sliding rails which enable sliding of the table desk in the horizontal position toward and outward a patient. The table desk frame is attached to a supporting member (supporting bar) on at least on side of the table desk frame. The supporting member of the side table is hollow. The supporting member comprises a control element on the top end of the supporting member. Inside the supporting member there is a rod, which is coupled to the control element on the top side and on the bottom part to an enclosure in which the entire pivotable locking mechanism is located. The pivotable locking mechanism of the side table comprises the control element, the rod, a pivot, a spring, a locking insertion, friction pads, and a locking member. The enclosure of the pivotable locking mechanism of the side table is attached to a profile on at least one side, which slides into a fixing bush attached to a base part of the side table. The base part of the side table is attached to at least one side of the bottom frame of the multifunctional chair. This base part of the side table is attached to the bottom frame of the multifunctional chair by means or screws, rivets, or may be an integral part of the bottom frame of the multifunctional chair. The fixing bush for fixing the side table has the same shape as the profile which slides into the fixing bush. Depending on profile length the side table can be fixed in different distances from the of support deck of the multifunctional chair. The fixing bush of the side table comprises a star locking mechanism due to which the side table can be easily attached to the frame of the multifunctional chair. In another embodiment, the side table can be attached to the chair by means of different locking mechanism such as quick release mechanisms, a lever or by using a split pin going through holes in a profile and the fixing bush of the side table.

In one embodiment, the table desk of the side table is a part of the multifunctional chair, the base part of the side table is a part of the base frame of the multifunctional chair or a support deck frame or a sitting part of the support deck of the multifunctional chair. In another embodiment, the base part of the side table can be removable and comprises screw fastening mechanism or quick release mechanism to be attached to the upper or bottom frame of the multifunctional chair. The base part of the side table can be attached to a side rail or an armrest of the chair, however in such case the pivotable locking mechanism needs to be adjusted in size according to a place of location on the armrest or side rail.

The pivotable locking mechanism of the side table is together with the supporting member inserted into the enclosure of the pivotable locking mechanism, wherein the supporting member comprises a control element on the top end of the supporting member. The pivotable locking mechanism is controlled by pushing the control element which releases locking of the pivot inside the enclosure by transferring force on a rod which enables rotating of table desk around vertical axis. A user pushes the rod which is coupled with pivot by control element. Upon pushing the rod by means of control element the pivot is released and pushed out of the locking member, which is located inside the enclosure of the pivotable locking mechanism. Returning into the original position is done by spring above the pivot which enables automatic locking without pushing the control element.

Pivotable locking mechanism of the side table locks the table desk at least in two positions, when turning the table desk always by 90° the table desk is automatically locked. Friction pads inside the enclosure of the pivotable locking mechanism provide continuous permanent rotation resistance. This restriction is intentional for the purpose of safety so that the side table could not move arbitrarily from a sitting patient when turning the table desk, or to avoid turning around of the table desk and hitting a nearby standing person or to avoid fast movement of the side table causing falling of any objects laying on the table desk down and thus causing a consequent injury of a patient or a caregiver. The pivotable locking mechanism with friction pads is sufficiently resistant to avoid any spontaneous movement and change of position of the table desk, however in parallel, resistant enough to enable the patient or caregiver to move the table desk into different angles around vertical rotation axis of the supporting member of the table desk.

Preferably, the pivotable locking mechanism enables rotation and locking of table desk around rotation axis into several positions. Each position of the table desk may be changed always by at least 90°, where pushing of control element releases locking member which causes rotation of the table desk by 90° either clockwise, or anticlockwise depending on a position from where to where the table desk should be positioned.

Majority of components of the multi-purpose side table is preferably produced from metal or metal alloys, but components can be produced also from plastic materials or plastic alloys. The control element may comprise plastic or rubber cover on the top part of the control element. The friction pads can be produced from metal, plastic materials, or rubber etc. The locking member of the side table can be a screw or stud fixed in the internal side of the enclosure of the pivotable locking mechanism, or preferably can be made of any suitable rigid material.

### LIST OF DRAWINGS

FIG. 1 shows a multifunctional chair with a side table in disengaged, deflected position.

FIG. 2 shows a side view of a multifunctional chair with a side table in engaged, service position.

FIG. 3 shows an adjustable side table comprising a fixing mechanism to be attached with to a multifunctional chair.

FIG. 4 shows detailed cross section view of released pivotable locking mechanism of a side table.

FIG. 5 shows detailed cross section view of locked pivotable locking mechanism of a side table.

### LIST OF REFERENCES

1. Medical chair
2. Pushing handle (of a medical chair)
3. Support deck (of a medical chair)
   3a) backrest part (of a support deck)
   3b) sitting part (of a support deck)
   3c) foot part (of a support deck)
4. Armrest
5. Support deck frame
6. Lifting mechanism (of a medical chair)
7. Base frame
8. Casters
9. Pivotable side table
10. Table desk
11. Table desk frame
12. Supporting member (of a side table)
13. Enclosure (of a locking mechanism)
14. Control element (of a locking mechanism)
15. Base part (of a side table)
16. Profile
17. Fixing bush (for fixing a table)
18. Locking mechanism of fixing the table
19. Cross-section view
20. Rod
21. Pivot (of a rod)
22. Spring
23. Locking insertion
24. Friction pads
25. Locking member

### EXEMPLARY EMBODIMENTS OF THE INVENTION

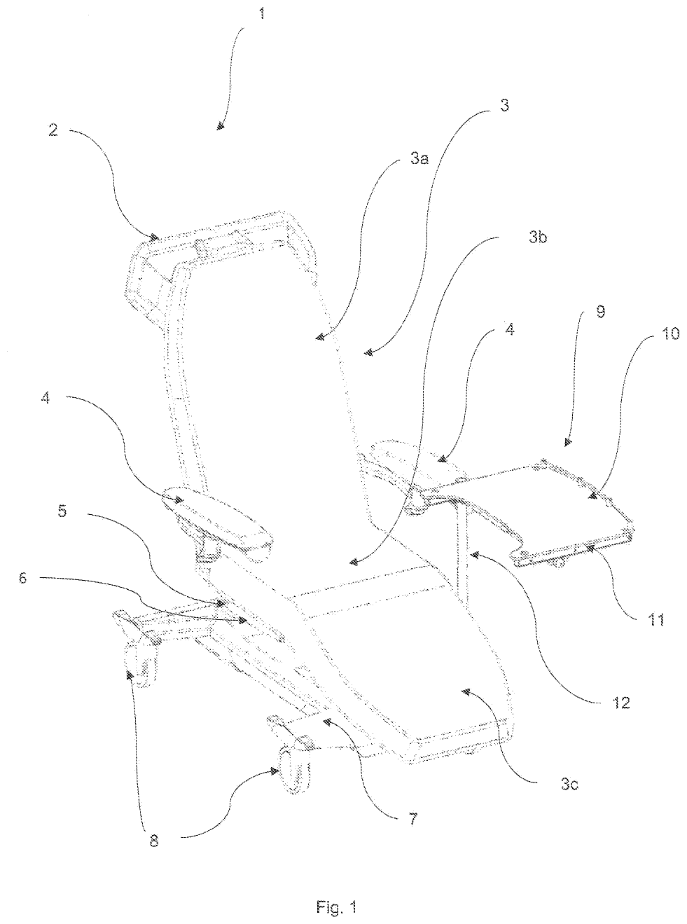

A disclosed technical solution relates to a multi-purpose pivotable side table 9 of a multifunctional chair 1, particularly to a mechanism of turning, shifting and locking of a table desk 10 of the side table 9 (i.e. pivotable locking mechanism). The multifunctional 1 is used for one-day or short-term surgery and medical treatments and interventions. The pivotable locking mechanism of the side table 9 causes easy attachment and consequent easy handling with a table desk 10 of the side table 9. The pivotable side table 9 may be then easily, safely, and expediently used by patients as well as caregivers in case of need. FIG. 1 shows axonometric view of the multifunctional chair 1 which comprises pushing handles 2, a support desk 3 further divided into three parts: a backrest part 3a, a sitting part 3b, and a foot part 3c. The multifunctional chair 1 further comprises adjustable articulating armrests 4 attached to a support deck frame 5. Optionally, the armrests 4 may be substituted by side rails for patient's safety. The FIG. 1 also shows that the multifunctional chair 1 comprises a base frame 7 with casters 8 comprising brake pedals, wherein the support deck frame 5 and the base frame 7 are mutually interconnected with a lifting mechanism 6, which is not shown and visible in this FIG. 1. The lifting mechanism 6 can be at least one telescopic column or more telescopic columns, or any other lifting mechanisms such as scissor lifting mechanism etc. The multifunctional chair 1 also comprises a pivotable side table 9, which is preferably added to the multifunctional chair 1 for a short-term care as an accessory. The FIG. 1 shows the table desk 10 in the disengaged, deflected position from the support deck 3 of the chair by 90°. The pivotable side table 9 of the multifunctional chair 1 comprises the table desk 10, a table desk frame 11 and a supporting member 12. The table desk 10 of the multifunctional chair 1 is preferably attached to the table desk frame 11, wherein such attachment is not shown in FIG. 1. The table desk 10 is attached to the table desk frame 11 by means of rivets, but also screws or any other joining material can be used. The table desk frame 11 also comprises sliding rails (not shown), which cause horizontal movement of the table desk 10 toward and outward a patient in the horizontal plane. Preferably, the pivotable side table 9 is possible to dismantle from the multifunctional chair 1.

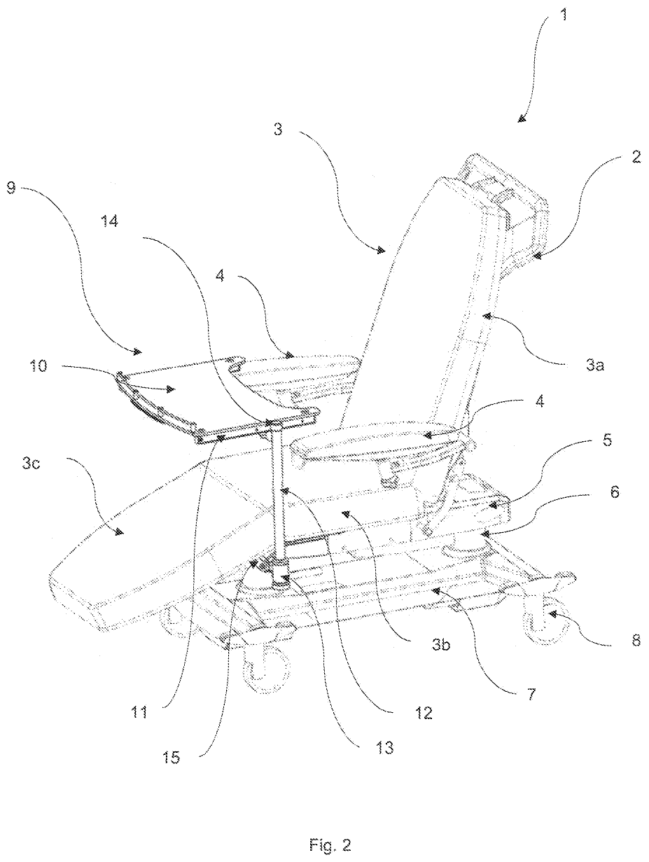

The FIG. 2 shows a multifunctional chair 1 from a side view together with a pivotable side table 9. The multifunctional chair 1 comprises a pushing handle 2 and a support deck 3 further divided onto three parts: a backrest part a, a sitting part 3b and a foot part 3c. The multifunctional chair 1 also comprises a support deck frame 5 and articulating armrests 4 attached to the support deck frame 5. A lifting mechanism 6 in the form of telescopic columns is attached to the support deck frame 5 on one side and on the other side to a base frame 7 of the multifunctional chair 1. The base frame 7 comprises casters 8 with brakes, also may comprise an electrically driven caster which is not shown in this FIG. 2. The FIG. 2 shows that a pivotable side table 9 is attached to the support deck frame 5 of the chair from the side, between the sitting part 3b and the foot part c of the support deck 3. In another embodiment the pivotable side table 9 can be attached to the support deck frame 5 at any point on the side, or the side table 9 can be attached to side part of the base frame 7 of the chair, or the side table 2 can be attached directly to the armrest 4 of the multifunctional chair 1. In case the pivotable side table 9 is attached to the armrest 4, a supporting member 12 of the table with an enclosure 13 of a pivotable locking mechanism shall be of proportional size with respect to type and place of attachment of the table desk 10.

The FIG. 2 shows that the pivotable side table 9 of the multifunctional chair 1 comprises the table desk 10, a table desk frame 11, and a supporting member 12, which comprises a control element 14 on the upper part and is fixed in an enclosure 13 of the locking mechanism on the bottom part. The enclosure 13 of the locking mechanism comprises a profile 16 on its side, which fits into a fixing bush 17 of the side table 9. The fixing bush 1 is a part of a base part 15 of the pivotable side table 9 and comprises a locking mechanism 18 for fixing the side table 9. The locking mechanism 18 can be a star locking mechanism or a quick release mechanism such as a cotter pin, which goes through holes in the fixing bush 17 of the side table 9 and a profile 16. The fixing bush 17 of the side table 9 may be arbitrary long, as well as the profile 16, which may comprise more holes for fixing the profile 16 in any random distance from the support deck 3 of the chair. In another embodiment, the profile 1§ as well as the fixing bush 17 may comprise holes for fixing the side table 9 in any random distance from the support deck 3 of the chair at least on one side. The table desk 10 is preferably produced wood, plastic material, laminated material, or any other suitable material. The table desk 10 is attached to the table desk frame 11 by means of rivets, but also screws or any other joining material can be used, such as glue. The table desk frame 11 may comprise also sliding rails (not shown) on which the table desk 10 moves horizontally.

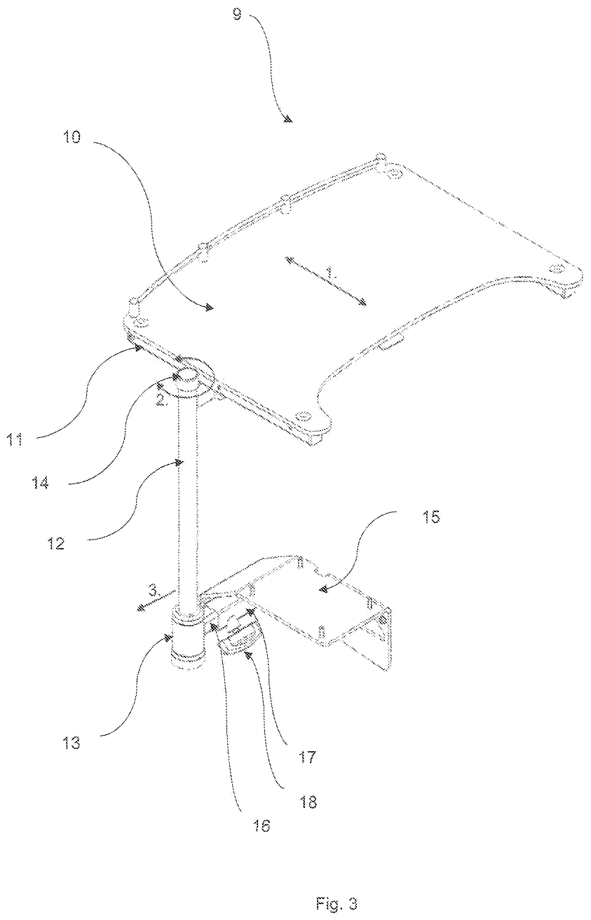

FIG. 3 shows axonometric view of a pivotable side table 9 of a multifunctional chair 1, wherein a table desk 10 is attached to a table desk frame 11 which is on at least one side attached to a supporting member 12. The supporting member 12 comprises a control element 14 on the upper part and is fixed in an enclosure 13 of the locking mechanism on the bottom part. The enclosure 13 of the locking mechanism is attached to a profile 16 on at least one side, the profile 16 fits into a fixing bush 17 for fixing the pivotable side table 9. The fixing bush 17 for fixing the pivotable side table 9 is a part of a base part 15 of the side table 9. The base part 15 can be a part of a support deck frame 5 of the chair, in another embodiment this base part 15 can be removable and attached to the support deck frame § by means of screws or rivets. The FIG. 3 shows apparently that the fixing bush 17 for fixing the pivotable side table 9 comprises a locking mechanism 18 for fixing the side table 9 further comprising a star locking mechanism, or in another embodiment different types of locking or fixing mechanisms such as quick release mechanisms (e.g. a lever, a cotter pin), or screws with nuts.

FIG. 3 also shows graphically three functions of the pivotable side table 9 of the multifunctional chair 1. The first function identified with FIG. 1 is movement of the table desk 10 horizontally by using sliding rails (not shown) located on the bottom side of the table desk 10 on a table desk frame 11. This function causes movement of the table desk 10 toward and outward a patient on the same plane along the entire length of the table deck frame 11.

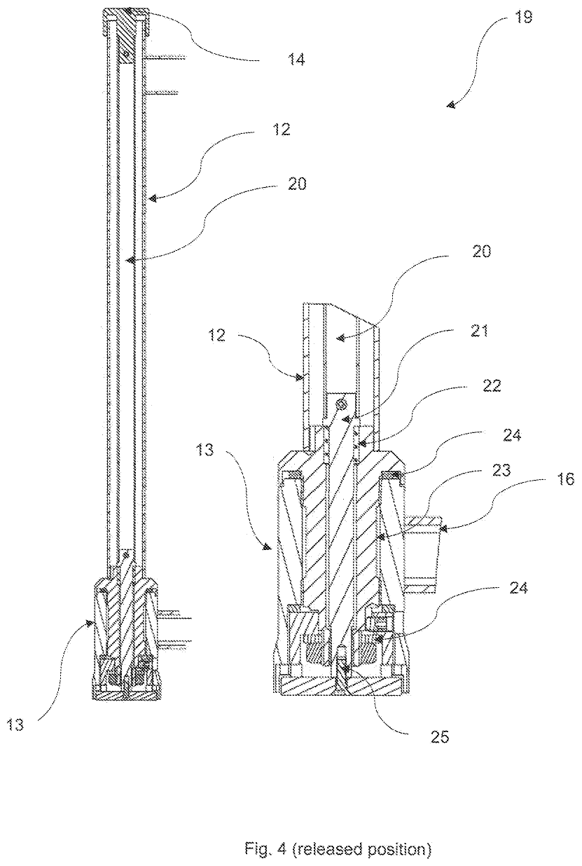

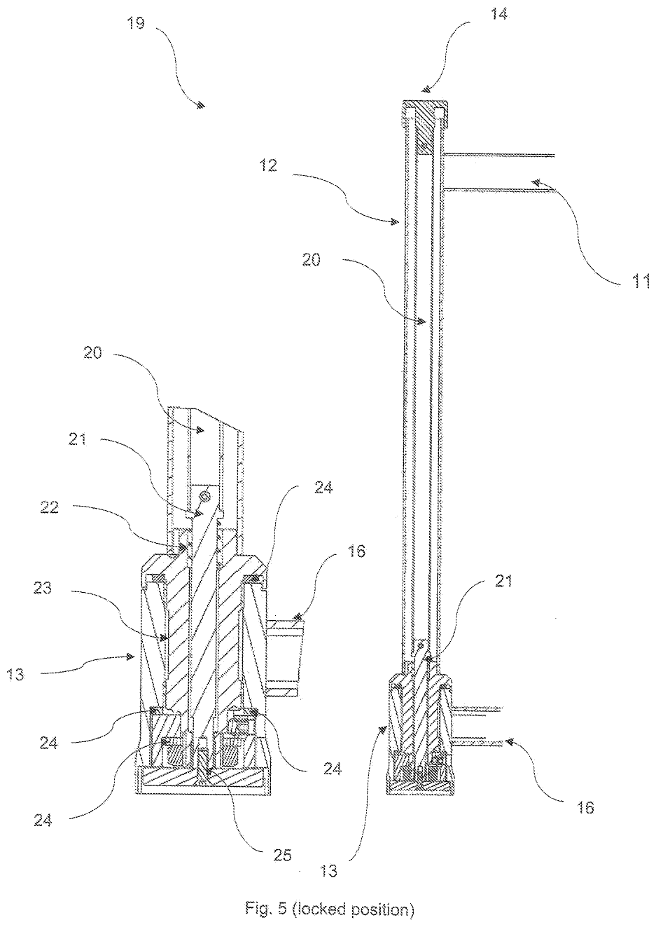

The second function identified with FIG. 2 is rotating of the table desk 10 around vertical rotation axis, when the table desk 10 of the side table 9 rotates around a supporting member 12 towards from a support deck 3 of the chair and along the support deck 3 outside the support deck 3, when the table desk 10 can be used by a caregiver as a storage side table for medical instruments and similar. The second function of rotation of the table desk 10 around vertical rotation axis is caused by pivotable locking mechanism located in an enclosure 13 of the pivotable locking mechanism. The pivotable locking mechanism comprises a control element 14 located on the upper end of the supporting member 12. The control element 14 is interconnected by a rod 20, which is located inside the supporting element 2, with a pivot 21 of the rod 20. The supporting member 12 is on the bottom side of the rod 20 together with the pivot 21 inserted into the enclosure 13 of the pivotable locking mechanism. The entire pivotable locking mechanism comprising the pivot 21 with a spring 22 and a locking insertion 23 with at least one friction pad 24 is located inside the enclosure 13 of the pivotable locking mechanism. A locking member 25 on which the pivot 21 causing the individual positions of the table desk 10 bears on is located on the bottom inner side of the enclosure 13 of the pivotable locking mechanism. These internal parts of the pivotable locking mechanism are shown on following FIGS. 4 and 5.

The third function identified with FIG. 3 is a possibility to remove the pivotable side table 9 from the multifunctional chair 1. The multifunctional chair 1 can be pre-equipped with preparation for location of the pivotable side table 9, which means that a support deck frame 5 of the chair comprises a base part 15 of the side table 9 with a fixing bush 17 for fixing the pivotable side table 9. Consequently, the pivotable side table 9 is then delivered without such base part 15 with fixing bush 17, as the multifunctional chair 1 is produced and sold with these components. In the latter case the pivotable side table 9 slides into the fixing bush 17 for fixing the pivotable side table 9 by means of a profile 16. In another embodiment, the entire base part 15 can be attached to the support deck frame 5 of the chair including the pivotable side table 9 and all aforementioned components.

The FIG. 4 shows two cross-section views of a mechanism of the second function of the pivotable locking mechanism in the released position which enables moving of a table desk 10 around vertical rotation axis. The first cross-section view shows the entire supporting member 12. The supporting member 12 comprises a pivotable locking mechanism whose locking part is located inside an enclosure 13 of the pivotable locking mechanism (details in released position are visible herein the FIG. 4). The first cross-section view of the entire supporting member 12 obviously shows that that the supporting member 12 comprises two ends, wherein the upper end of the supporting member 12 comprises a control element 14, and at the other end the supporting member 12 is anchored inside the enclosure 13 of the pivotable locking mechanism. The pivotable locking mechanism is controlled by the control element 14. The pivotable locking mechanism comprises the control element 14 which continues with a rod 20, which is coupled to a pivot 21 of the rod 20 on which a spring 22 is attached. The pivot 21 of the rod 20 is located inside a locking insertion 23, wherein the locking insertion 23 is restricted on the upper and bottom part together with the pivot 21 of the rod 20 by friction pads 24. The pivot 21 of the rod 20 of the pivotable locking mechanism comprises a locking member 25, wherein the FIG. 4 shows obviously that the pivot 21 of the rod 20 is in the released position as this pivot 21 of the rod 20 pushed out of the groove of the locking member 25, by which the supporting member 12 of the table desk 10 inside the enclosure 13 of the pivotable locking mechanism is released causing rotation or turning of the table desk 10.

The FIG. 5 shows two cross-section views of a mechanism of the second function of the pivotable locking mechanism in the locked position which fix the position of the table desk 10 and prevents moving of a table desk 10 around vertical rotation axis. The first cross-section view shows the entire supporting member 12. The supporting member 12 comprises a pivotable locking mechanism whose locking part is located inside an enclosure 13 of the pivotable locking mechanism (details in locked position are visible herein the FIG. 5). The first cross-section view of the entire supporting member 12 obviously shows that that the supporting member 12 comprises two ends, wherein the upper end of the supporting member 12 comprises a control element 14, and at the other end the supporting member 12 is anchored inside the enclosure 13 of the pivotable locking mechanism. The pivotable locking mechanism is controlled by the control element 14. The pivotable locking mechanism comprises the control element 14 which continues with a rod 20, which is coupled to a pivot 21 of the rod 20 on which a spring 22 is attached. The pivot 21 of the rod 20 is located inside a locking insertion 23, wherein the locking insertion 23 is restricted on the upper and bottom part together with the pivot 21 of the rod 2Q by friction pads 24. The pivot 21 of the rod 20 of the pivotable locking mechanism comprises a locking member 25, wherein the FIG. 5 shows obviously that the pivot 21 of the rod 20 is in the locked position as this pivot 21 of the rod 20 is inserted and bears onto the groove of the locking member 25, by which the supporting member 12 of the table desk 10 inside the enclosure 13 of the pivotable locking mechanism is locked causing fixation and impossibility of turning the table desk 10.

1. A pivotable side table comprising a table desk, a table desk frame, a supporting member, an enclosure of a pivotable locking mechanism, wherein the pivotable locking mechanism further comprises a control element, a rod, and a pivot of the rod, a spring, a locking insertion with at least one friction pad, and a locking member.

2. The pivotable side table according to claim 1, wherein the control element is located on an upper end of the supporting member.

3. The pivotable side table according to claim 1, wherein the control element is coupled with the rod and the pivot causing position in the locking member.

4. The pivotable side table according to claim 1, wherein the rod, the pivot, the spring, the locking insertion and at least one friction pad and the locking member are made from metal or metal alloy.

5. The pivotable side table according to claim 1, wherein the control element controls the rod and the pivot so that the pivot is released from the locking member.

6. The pivotable side table according to claim 1, wherein the pivotable locking mechanism is located inside the supporting member and the enclosure of the pivotable locking mechanism.

7. A method of using the pivotable locking mechanism according to claim 1, wherein pushing the control element causes transferring of force via the rod onto the pivot by which the pivot is released from the locking member thus releasing the supporting member in the enclosure of the pivotable locking mechanism.

8. The method of using the pivotable locking mechanism according to claim 7, wherein pushing the control element causes transferring of force via the rod onto the pivot by which the pivot is released from the locking member thus releasing the table desk.

9. The method of using the pivotable locking mechanism according to claim 7, wherein releasing the control element causes transferring of force via the spring onto the pivot by which the pivot is locked to the locking member thus fixing the position of the table desk.

10. The method of using the pivotable locking mechanism according to claim 9, wherein releasing the control element causes transferring of force via the spring onto the pivot by which the pivot is locked to the locking member thus fixing the position of the supporting member in the enclosure of the pivotable locking mechanism.

11. A pivotable side table for a medical chair, the pivotal side table comprising a table desk attached to a table desk frame, a supporting member having a bottom part supported in relation to an enclosure, which is attachable to the medical chair, the enclosure forming a part of a pivotable locking mechanism, the pivotable locking mechanism further comprising a control element supported in relation to an upper part of the supporting member and coupled to an upper part of a rod and a pivot coupled to a lower part of the rod, the pivotable locking mechanism further comprising a spring, a locking insertion with at least one friction pad and a locking member located inside the enclosure, wherein the control element is moveable to affect movement of the rod and the pivot in a first direction against force of the spring to release the locking insertion with at least one friction pad from the locking member to permit pivotal movement of the table desk, and wherein upon releasing the control member, the spring urges the rod and the pivot in a second direction to engage the locking insertion with at least one friction pad from the locking member to resist movement of the table desk.

12. The pivotable side table according to claim 11, wherein the control element is located at an upper end of the supporting member.

13. The pivotable side table according to claim 11, wherein the rod, the pivot, the spring, the locking insertion and at least one friction pad and the locking member are made from metal or metal alloy.
